(19) United States
(12) Patent Application Publication
(10) Pub. No.: US 2022/0129727 A1
(43) Pub. Date: Apr. 28, 2022

(54) Multi-Phase Training Techniques for Machine Learning Models Using Weighted Training Data

(71) Applicant: PayPal, Inc., San Jose, CA (US)

(72) Inventors: Shi Chen, Shanghai (CN); Shuoyuan Wang, Shanghai (CN); Jiaqi Zhang, Shanghai (CN)

(21) Appl. No.: 17/465,343

(22) Filed: Sep. 2, 2021

(30) Foreign Application Priority Data
Oct. 27, 2020 (CN) PCT/CN2020/123861

(51) Int. Cl. G06N 3/04

(52) U.S. Cl. CPC G06N 3/04

(57) ABSTRACT

Techniques are disclosed relating to multi-phase training of machine learning models using weighted training data. In some embodiments, a computer system may train a machine learning classification model in at least two phases. During an initial training phase, the computer system may train an initial version of the classification model based on a training dataset, applying equal weight to the training samples in the training dataset. The computer system may then generate model scores for the training samples using the initial version of the classification model. Based on these model scores, the computer system may generate, for the training samples, corresponding weighting values. The computer system may then perform a subsequent training phase to generate an updated version of the classification model, where, during this subsequent training phase, at least some of the training samples are weighted using their respective weighting values.

### PRIORITY CLAIM

The present application claims priority to PCT Appl. No. PCT/CN2020/123861, filed Oct. 27, 2020, which is incorporated by reference herein in its entirety.

### BACKGROUND

### Technical Field

This disclosure relates generally to improved techniques for training machine learning models, and more particularly to multi-phase training techniques that use weighted training data in at least one of the phases to train machine learning models, according to various embodiments.

### Description of the Related Art

Server systems utilize various techniques to detect risks to their systems and the services they provide. Many risk detection problems can be characterized as “classification problems” in which an observation is classified into one of multiple categories based on the features of that observation. As one non-limiting example, the problem of “spam” (unwanted email) detection may be considered a binary classification problem for which a classification model may be used to generate a probability value indicating the likelihood that an inbound email should be classified as “spam” (or “not spam”).

One technique for generating a classification model is to train an artificial neural network on a training dataset of prior observations (e.g., emails, in the current example) such that, once trained, the model is capable of categorizing new observations. For example, existing training techniques optimize classification models “globally” such that a model's accuracy is relatively consistent across the entire distribution of predicted probability values. Such training techniques present various technical shortcomings, however. For example, as described in greater detail below, existing training techniques may limit a model's ability to accurately classify new observations, degrading the performance of the classification model.

### BRIEF DESCRIPTION OF THE DRAWINGS

FIG. 1 is a block diagram illustrating an example training module that is operable to train a classification model using a multi-phase training operation, according to some embodiments.

FIG. 2 is a block diagram illustrating a computer system that includes an example training module and weighting value generator, according to some embodiments.

FIG. 3 is a block diagram illustrating an example training module performing various operations during a second training phase, according to some embodiments.

FIG. 4 is a block diagram illustrating an example server system and authorization module that uses a classification model to determine whether to authorize a request, according to some embodiments.

FIGS. 5A-5B are graphs respectively depicting example distributions of unweighted and weighted model scores, according to some embodiments.

FIG. 6 is a flow diagram illustrating an example method for training a machine learning model using a multi-phase training technique, according to some embodiments.

FIG. 7 is a block diagram illustrating an example computer system, according to some embodiments.

### DETAILED DESCRIPTION

Many technical problems can be characterized as “classification problems” in which an item is to be categorized into one of multiple classes. One special case of the classification problem is the “binary classification problem” in which there are only two classes into which an item may be categorized. A non-limiting example of a binary classification problem is spam filtering, where an in-bound email is analyzed and categorized as either “spam” or “not spam.” One technique for solving binary classification problems is to use a trained classification model to “predict” the probability that a particular element belongs to one of the two classes. If that probability exceeds some particular threshold value, that element may be classified as belonging to one class (“class A”) and, if not, that element may be classified as belonging to a second class (“class B”). The particular threshold value used to determine the class to which an input element should be classified may vary depending, for example, on the technical problem for which the classification model is being used, though it is common for such a threshold value to be relatively high (e.g., 80%, 85%, 90%, 99%, etc.).

For example, consider a spam-filtering system that uses a trained binary classification model to determine whether to categorize an inbound email as “spam” or “not spam.” Upon receiving an inbound email, the classification model may be used to analyze various features (also referred to as “attributes”) associated with the email (e.g., sender domain, time sent, keywords present, etc.) and generate a value indicating the probability that the email should be categorized as “spam.” If that probability exceeds some threshold value (e.g., 85%), the spam filtering system may categorize that email as “spam” and take an appropriate action, such as routing the email into a spam folder.

Binary classification models (implemented, for example, using artificial neural networks (“ANNs”)) are often trained using an iterative process in which the model's parameters are optimized so as to reduce an error value provided by a loss function. Using these prior training techniques, the parameters are optimized when the error value provided by the loss function reaches its lowest value, optimizing the model “globally” such that it performs well across the entire distribution of prediction values.

Such training techniques present various technical shortcomings, however. For example, Applicants recognize a tension between the training objectives and the usage objectives for classification models. In many instances, accuracy of the model at one end of the probability distribution is less important when using the model to categorize an element into one of the identified classes (that is, to solve classification problems). For example, in the spam-filtering example above in which the threshold value used to classify emails is set to 0.85, it can be considered inconsequential for an inbound email to be given a model score of 0.3 (indicating a 30% probability that the email is spam) versus a model score of 0.4—in both cases, the email is going to be classified as “not spam,” and is not near the decision threshold of 0.85. Thus, in such an instance, the model's lack of accuracy at the lower end of the probability distribution would not materially affect the efficacy of the model. If, however, the model lacks accuracy at the upper end of the distribution (between the ranges of 0.8-0.9, for example), this would significantly impact the ability of the model to accurately classify elements into their appropriate classes. Accordingly, in the scenario described above, the objective for which the binary classification model is trained—to be optimized to perform well across the entire spectrum of predicted probability values—does not perfectly align with the objective for which the binary classification model is used—high accuracy at one end (e.g., the upper end) of the predicted probability value spectrum with less emphasis on the accuracy at the other end (e.g., the lower end).

Further, some training techniques apply the same weight to all of the training samples in the training dataset, which may present various technical problems when training a classification model. For example, in the context of binary classification problems, the distribution of labeled training data may be drastically skewed in favor of one of the two classes. As a non-limiting example, in the context of fraud detection in an online payment system, the vast majority (e.g., 95%, 98%, etc.) of attempted transactions may be legitimate with only a small subset of attempted transactions being fraudulent. In such instances, using prior observances (e.g., emails, electronic transactions, etc.) in the proportion in which they are observed as the training samples in a training dataset may lead to a training dataset that is skewed with training data in one of the multiple classes (e.g. the vast majority of training data may be legitimate transactions, most of which are not close to a “threshold” for being categorized as fraud, when scored by a machine learning classifier). As will be appreciated by one of skill in the art with the benefit of this disclosure, training a classification model on such a skewed training dataset may negatively impact the efficacy of the resulting model.

Other approaches to address this technical problem present various shortcomings. For example, one such approach is to “even out” the distribution of the training dataset by removing some of the training samples belonging to the overrepresented class (e.g., some subset of the “not spam” emails). This approach also negatively impacts the ultimate efficacy of the resulting classification model, however, because by reducing the size of the training dataset, the model is unable to learn useful patterns that may be present in the training samples that were removed, thereby degrading the performance of the model.

In various embodiments, however, the disclosed techniques provide a technical solution to these problems by applying a multi-phase training technique that uses weighted training data (in at least one of the phases) to train classification models. For example, in various embodiments, during a first training phase, the disclosed techniques include training a first version of a classification model based on a training dataset, giving equal weighting to the training samples in the training dataset during this first training phase. Using this first version of the classification model, the disclosed techniques may then create model scores based on the training samples in the training dataset. As used herein, the term “model score” refers to a value, generated by a classification model, which indicates the probability that a corresponding training sample should be classified into a one of a set of classes. For example, in some embodiments, a particular training sample may be applied to the first version of the classification model to generate a model score indicative of the probability that the particular training sample should be classified into one of multiple classes.

Further, in various embodiments, the disclosed techniques include performing one or more transformations based on the model scores to generate, for the training samples in the training dataset, corresponding weighting values. In various embodiments, the weighting value for a given training sample is based on the probability that the given training sample belongs to a particular one of the set of classes, as explained in more detail below. The disclosed techniques may then perform a second training phase, during which additional training is performed on the classification model (using the first version of the classification model as a “starting point”) based on the training dataset to generate a second version of the classification model. In various embodiments, during this second training phase, the training samples in the training dataset are weighted based on the weighting values. As explained in more detail below, by weighting the training samples in this manner, the disclosed techniques are capable of placing more emphasis on training samples in a desired portion of the model score distribution, which may present various technical benefits. For example, as explained in more detail below, the disclosed multi-phase training techniques may, in various embodiments, improve the accuracy of the resulting classification model in a portion of the model score distribution that is most important for making classification determinations. This, in turn, may improve the efficacy of the classification model when used to make classification determinations on live inputs (e.g., for spam classification, fraud detection, or any other suitable purpose), thereby improving the functioning of the system as a whole.

Note that, in some instances, other techniques for generating classification models may generate a “high risk” model in an attempt to improve their model's accuracy in the upper end of the model score distribution. Using such an approach, the system may first train a model based on a training dataset, applying equal weighting to each of the training samples in the training dataset. The system may then apply the training samples to the trained model and select the training samples that receive a relatively high model score as the training samples to include in a new training dataset. Then, using this approach, such systems then train an entirely new model using this new training dataset. This “high risk” model approach also presents various technical shortcomings. For example, using such an approach, the model parameters for the high risk model are randomly initialized when trained using the new training dataset, reducing the likelihood that optimal values for the model's parameters will be reached. In various embodiments, however, the presently disclosed techniques inherit parameters, during the second training phase, from an initially trained version of a classification model and use the second training phase to further refine these parameters, increasing the ability of the disclosed techniques to determine optimal values for the classification model's parameters. Further, the “high risk” model approach may only use a high model score portion of the original training dataset to train the “high risk” model, ignoring useful patterns that could be gleaned from the training samples that it excludes. Additionally, since the “high risk” model uses a smaller training dataset, this approach presents a higher risk of overfitting than the disclosed multi-phase training techniques.

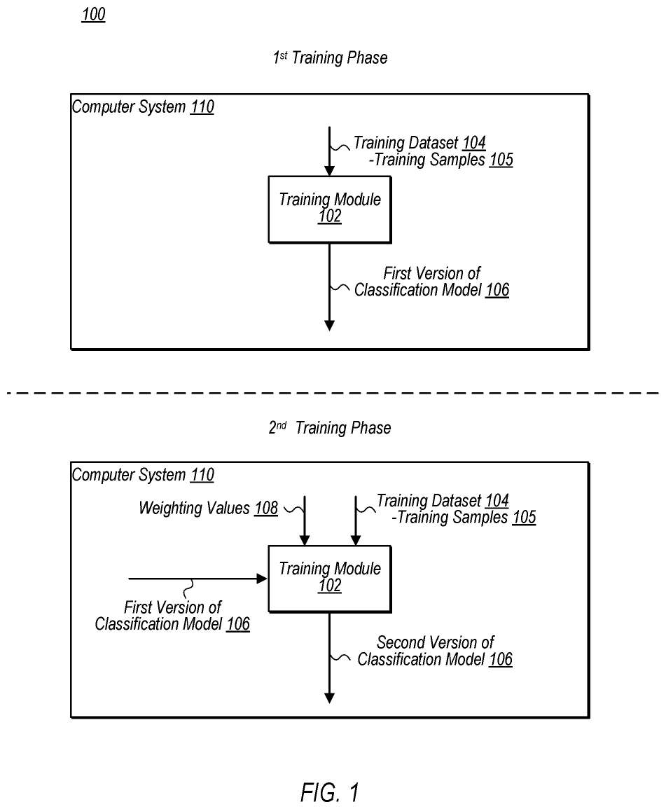

Referring now to FIG. 1, block diagram 100 depicts a training module 102 that is operable to train a classification model 106 using a multi-phase training operation. In the depicted embodiment, for example, the training operations include a first training phase and a second training phase. In some embodiments, during the first training phase, a classification model 106 (implemented, for example, using an ANN) may be trained using a training dataset 104 that includes labeled training samples 105A-105N. In various embodiments, the training samples 105 in the training dataset 104 may each specify various attributes (as part of a “feature vector”) about the particular sample 105. In the spam-filtering example above, for instance, the training dataset 104 may include training samples 105 corresponding to previously received emails, where a given training sample 105 specifies various attributes about a prior email and a label indicating the class to which the email belongs (e.g., “spam” or “not spam”). As another non-limiting example, in embodiments in which the classification model 106 is used to detect fraudulent transactions, the training dataset 104 may include training samples 105 corresponding to prior electronic transactions, where a given training sample 105 specifies various attributes about a prior transaction (e.g., amount, date, time, origin of request, etc.) and a label indicating the class to which the prior transaction belongs (e.g., “fraudulent” or “not fraudulent”).

The classification model 106 may be trained using any of various suitable training techniques and utilizing any of various suitable machine learning libraries to train the classification model 106 during the first and second training phases, including Pandas™, Scikit-Learn™, Tensorflow™, or any other suitable library. In some embodiments, the classification model 106 is implemented as an ANN. In some such embodiments, the training performed during the first training phase may include using the adaptive moment estimation (“Adam”) optimization algorithm to iteratively optimize parameters of the ANN based on the cross-entropy loss function. Note, however, that this embodiment is provided merely as an example and, in other embodiments, various suitable training techniques may be used. For example, in other embodiments, any suitable optimization algorithms, such as stochastic gradient descent, may be used to optimize any suitable cost function, as desired. Further note that, in embodiments in which the classification model 106 is implemented using an ANN, any of various neural network architectures may be used, including a shallow (e.g., two-layer) network, a deep artificial neural network (in which there are one or more hidden layers between the input and output layers), a recurrent neural network (RNN), a convolutional neural network (CNN), etc. In various embodiments, the training samples 105 in the training dataset 104 are all given equal weighting during this initial training phase. By completing the first training phase, the disclosed techniques, in various embodiments, create an initial version of the classification model 106 that is optimized across the entire spectrum of model scores and is capable of classifying input elements into one of the multiple classes.

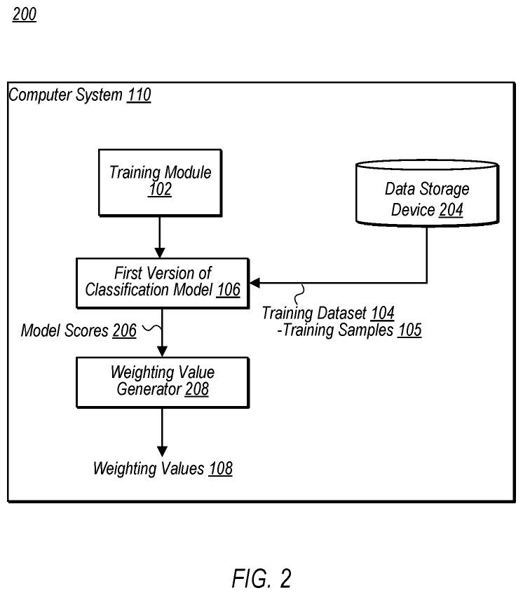

In various embodiments, the first version of the classification model 106 may then be used to generate model scores for the training samples 105 in the training dataset 104, and the model scores, in turn, may be used to generate the weighting values 108 for the training samples 105. The manner in which the weighting values 108 are generated, according to some embodiments, is described in detail below with reference to FIG. 2. For the purposes of the present discussion, note that, in various embodiments, the weighting values 108 are calculated so as to give more weight to those training samples that have model scores in a certain portion of the probability distribution (e.g., training samples having higher model scores) than those training samples that have model scores in a different portion of the probability distribution (e.g., training samples having lower model scores). Stated differently, in some embodiments, the disclosed techniques include weighting the training samples 105 in the training dataset 104 based on their respective model scores such that, during the second training phase, training samples 105 with lower model scores are given less weight and training samples 105 with higher model scores are given more weight. (Note, however, that this example is provided merely as one non-limiting embodiment and, in other embodiments, the weighting values 108 may be generated so as to give additional weight to training samples 105 in any desired portion of the model score distribution.) In such embodiments, weighting the training samples 105 in this manner may adjust the distribution of the model scores for the training dataset from a distribution that is heavily skewed on one end (e.g., in instances in which the majority of training samples correspond to a particular classification) into a distribution that more closely resembles a Gaussian distribution (also referred to as a “normal” distribution).

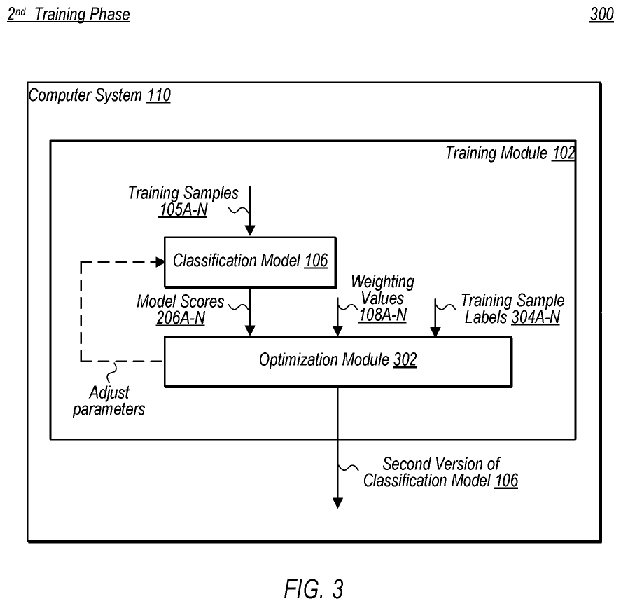

In various embodiments, the disclosed techniques may then perform a second training phase to further train the classification model 106. The second training phase, according to some non-limiting embodiments, is described in detail below with reference to FIG. 3. Note, however, that in various embodiments, the second training phase uses the first version of the classification model 106 (from the first training phase) as a starting point and, through the second training phase, further refines the classification model 106. During the second training phase, in various embodiments, the training samples 105 in the training dataset 104 are weighted based on their respective weighting values 108. For example, during the second training phase, the disclosed techniques, in various embodiments, may weight the loss associated with a model score for a given training sample based on the weighting value calculated for that given training sample. The disclosed techniques, in various embodiments, may use a cost function and the weighting values during the second training phase to evaluate the performance of the classification model and, based on that performance, refine the parameters (e.g., network weights) of the classification model 106.

In various embodiments, using weighted training samples to further refine an initially trained classification model may provide various technical benefits. For example, in various embodiments, the disclosed techniques better match the training objectives and the usage objectives of the classification model by placing more emphasis on a selected range (e.g., an upper end, in some embodiments) of the probability distribution. As noted above, one portion of the model score distribution, in many contexts, may be more relevant for performing classification determinations than the other portion(s) of the model score distribution. For instance, in the example described above in which an incoming email is classified as “spam” if a corresponding model score exceeds 0.85, it is the “upper” end of this model score distribution that is most relevant for classified input elements. In various embodiments, the disclosed multi-phase training techniques are operable to train classification models 106 that are more accurate (and, in at least some embodiments, more precise) in the portion of the model score distribution that is relevant for the performing the classification determination. For example, in various embodiments, the weighting values are generated so as to place a greater emphasis on (that is, weigh more heavily) training sample 105 with higher model scores during the second training phase. In some such embodiments, weighting the training samples in this manner during the second training phase improves the classification model's accuracy in the “upper” end of the prediction distribution, thereby improving the model's ability to accurately classify new input elements (that is, inputs that were not used as part of the training process) for which the model score falls into the “upper” end of the prediction distribution. In various embodiments, the disclosed techniques may improve the accuracy of the resulting classification model 106 in an upper end of the model score distribution, thereby improving the model's ability to accurately classify elements into the appropriate category.

Note that, in various embodiments, this increase in the classification model 106's accuracy at the upper end of the model score distribution may result in the model becoming relatively less accurate in the “lower” end of the prediction distribution. In most cases, however, such a tradeoff does not negatively impact the ability of the classification model 106 to accurately classify input elements into appropriate classes because, as will be appreciated by one of skill in the art with the benefit of this disclosure, small deviations in an input element's model score at the lower end of the distribution are unlikely to change the ultimate classification determination for that input element.

Additionally, in various embodiments, the disclosed techniques transforms the distribution of the training data in the training dataset such that it varies smoothly, rather than having a distribution that is drastically skewed (as is sometimes the case in binary and multi-label classification problems). Applicant notes that, in some instances in which there is an extreme bias in the distribution of training samples, a minority of the training samples may have a disproportionate amount of weight while other training samples may have almost the same level of weight, which may negatively impact the model training process. Accordingly, by weighting the training samples 105 as disclosed herein, the disclosed techniques may improve the quality of the resulting classification model 106.

Further, note that although only two training phases are shown in FIG. 1, this embodiment is provided merely as one non-limiting example. In other embodiments, for example, the disclosed techniques may include performing additional training phases at various points in the model-training process (e.g., before the “first training phase,” in between the “first training phase” and the “second training phase,” after the “second training phase,” or any combination thereof). Accordingly, the “first” and “second” training phases described herein may alternatively be referred to as “initial” and “subsequent” training phases, respectively, to denote that the multi-phase training techniques disclosed herein include an “initial training phase” that is performed prior to the “subsequent training phase,” regardless of whether any additional “training phases” are also performed.

Turning now to FIG. 2, block diagram 200 depicts an example computer system 110 that includes training module 102, data storage device 204, and a weighting value generator 208. In various embodiments, the weighting value generator 208 is operable to generate weighting values 108 for the training samples 105 based on the respective model scores 206 for those training samples 105.

For example, in the depicted embodiment, the training module 102 generates a first version of the classification model 106 during a first training phase, as described above. In various embodiments, the first version of the classification model 106 may then be used to generate model scores 206 for the training samples 105 in the training dataset 104. For example, in some embodiments, a training sample 105 may be applied to the first version of the classification model 106 to generate a model score 206, which indicates the probability that the training sample 105 should be categorized into one of the specified set of classes. In some embodiments, these model scores 206 may be generated on a scale from 0.0-1.0, though other ranges may be used as desired. For example, in embodiments in which the classification model 106 is a binary classification model, the model scores 206 may be generated on a scale from 0.0-1.0 and indicate the probability that an input element should be classified into one of two classes, with model scores 206 closer to 0 indicating that the training sample 105 should be classified in a first category (e.g., “not spam”) and model scores 206 closer to 1 indicating an increasing probability that the training sample 105 should be classified in a second category (e.g., “spam”). In various embodiments, this process of generating a model score 206 based on a given training sample 105 may be performed for all of the training samples 105 in the training dataset 104 such that each training sample 105 in the training dataset 104 has a corresponding model score 206. Note, however, that in some embodiments, the disclosed techniques may modify the weighting of any desired subset of training samples 105 for use in the second training phase, such as training samples 105 for which the corresponding model scores 206 are in a certain portion of the model score distribution. As one non-limiting example, in some embodiments, the disclosed techniques may generate weighting values 108 only for those training samples 105 for which the corresponding model scores are above some predetermined threshold value (e.g., 0.5, 0.75, etc.) and, for the remaining training samples 105, the weighting value may be left unchanged (e.g., with a weighting value of 1) such that these training samples 105 are given equal weight during the second training phase.

In FIG. 2, computer system 110 further includes weighting value generator 208, which, in various embodiments, is operable to perform one or more transformations to generate weighting values 108 for the training samples 105 based on their respective model scores 206. For example, in some embodiments, the weighting value generator 208 is operable to generate a weighting value 108i for a given training sample 105i as follows:

$$Weight ( i ) = \frac{ln ( Score ( i ) ) - ln {Score}_{min}}{ln {Score}_{max} - ln {Score}_{min}} + 1$$

where Score(i) is the model score 206i generated for the training sample 105i using the first version of the classification model 106, InScoreₘᵢₙ is the minimum value identified when taking the natural logarithm of the model scores 206 for the training samples 105 in the training dataset 104, and InScoreₘₐₓ is the maximum value identified when taking the natural log of the model scores 206 for the training samples 105 in the training dataset 104. In this non-limiting embodiment, the weighting value generator 208 the natural logarithm function to generate the model scores 206, allowing the disclosed techniques to transform the distribution of model scores 206 from a distribution that is heavily skewed into one that, once weighted, more closely resembles a Gaussian distribution. Note, however, that this example technique for generating the weighting values 108 is merely provided as one non-limiting embodiment and, in other embodiments, various other suitable techniques may be used. For example, in some embodiments, the logarithmic function in the above equation may be replaced with the logit transformation or the Box-Cox transformation (or any other suitable function) and the constant value (1, in the above equation) may be modified as desired (e.g., to 0.5, 0.75, 1.5, 2.0, etc.).

In various embodiments, a weighting value 108 may be calculated for each (or some subset) of the training samples 105 in the training dataset to generate a set of weighting values 108. As described in more detail below, the weighting values 108 may be used by the training module 102 to weight the training samples 105 during a second training phase, in various embodiments. For example, for a training sample 105A, the disclosed techniques may include generating a model score 206A using the initial version of the classification model 106 and, based on the model score 206A, calculating a weighting value 108A. In this example, when the training sample 105A is used in the second training phase to further refine the classification model 106, the weighting value 108A may be used as a training weight for the training sample 105A. A detailed discussion of the second training phase, according to some embodiments, follows with reference to FIG. 3.

In FIG. 3, block diagram 300 depicts an example training module 102, according to some embodiments. In the depicted embodiment, training module 102 is shown performing various operations during a second phase of a multi-phase training operation. For example, in FIG. 3, training module 102 includes an optimization module 302 that is operable to iteratively optimize the parameters of classification model 106 using the parameters of the first version of the classification model 106 (generated during the first training phase) as a starting point for the parameters of the classification model 106.

In embodiments in which the classification model 106 is implemented using an ANN, optimization module 302 may iteratively modify the network weights of the ANN during the second training phase. Optimization module 302 may utilize any of various suitable machine learning optimization algorithms to modify the parameters of the classification model 106 in an attempt to minimize a cost function. Further, in various embodiments, optimization module 302 may utilize any of various suitable cost functions. For example, in some embodiments, optimization module 302 may use the following cost function that is based on the binary cross-entropy loss function:

$${H}_{p} ( q ) = - {\sum }_{i = 1}^{N} \frac{1}{N} [ {y}_{i} * log ( p ( {y}_{i} ) ) + ( 1 - {y}_{i} ) * log ( 1 - p ( {y}_{i} ) ) ]$$

where N indicates the number of training samples 105 used, yᵢ is the label 306 for the training sample 105i (e.g., 0 if the training sample 105i belongs to a first class, 1 if the training sample 105i belongs to a second class), and p(yᵢ) is the model score 206i predicted for the training sample 105i using the current iteration of the classification model 106. In such embodiments, the loss associated with a given training sample 105i is provided as follows:

L(i)=[yᵢ*log(p(yᵢ))+(1−yᵢ)*log(1−p(yᵢ))]

As noted above, however, optimization module 302 may utilize the weighting values 108 during the second training phase, according to various embodiments. For example, in some embodiments, optimization module 302 may weight the loss associated with a prediction (that is, a model score 206) made for a particular training sample 105 based on the weighting value 108 calculated for that training sample 105. Thus, in some embodiments, the cost function utilized by the optimization module 302 during the second training phase may be re-written as follows:

$${H}_{p} ( q ) = - {\sum }_{i = 1}^{N} \frac{{w}_{i}}{N} [ {y}_{i} * log ( p ( {y}_{i} ) ) + ( 1 - {y}_{i} ) * log ( 1 - p ( {y}_{i} ) ) ]$$

where wᵢ is the weighting value 108i for the training sample 105i. Note, however, that this embodiment is provided merely as one non-limiting example and, in other embodiments, the optimization module 302 may weight the training samples 105 using the weighting values 108 using other suitable techniques. As non-limiting examples, in some embodiments, optimization module 302 may use the hinge loss function or the modified Huber loss function. In instances in which a different cost function is used during the optimization process, the optimization module 302 may use the weighting values 108 to weight the loss terms associated with the predictions (that is, model scores 206) made, using the alternative cost function, for the training samples 105.

In various embodiments, the optimization module 302 may use the cost function and weighting values 108 to evaluate the performance of the classification model 106 and, based on that performance, determine the manner in which to modify one or more parameters of the classification model 106, for example using the Adam optimization algorithm. After modifying these parameters, the optimization module 302 may generate new model scores 206 using the current iteration of the classification model 106 and again evaluate the classification model 106's performance. In various embodiments, optimization module 302 may repeat this process (e.g., for 2-10 more epochs) until the optimization module 302 has determined parameters for the classification model 106 that sufficiently minimize the cost function. For example, in some embodiments, optimization module 302 may repeat this process until the re-weighted loss function for a validation dataset does not decrease for a particular number of epochs (e.g., 3, 5, 7, etc.), at which point the optimization module 302 may cease the current training operations.

Note that, during this second training phase, the optimization module 302 is using the first version of the classification model 106, which has already been trained using the training dataset 104, as a starting point. In such embodiments, since the parameters of the first version of the classification model 106 have already been optimized using the (unweighted) training dataset 104 once, it is likely that these parameters are relatively close to what will ultimately be determined, through the second training phase, as their optimal values. Accordingly, in some embodiments, the learning rate utilized by the optimization module 302 in the second training phase may be reduced (e.g., to 0.0001, 0.0002, 0.0003, etc.) such that it is lower than the learning rate used by the optimization module 302 during the first training phase, which may reduce the risk of “overshooting” during the second training phase. As noted above, in various embodiments, the disclosed second training phase may be used to generate classification models 106 that are more accurate in a desired portion of the model score probability distribution (e.g., an upper end of the distribution), which, in turn, may improve the ability of the classification model 106 to accurately classify previously unseen input elements into an appropriate class.

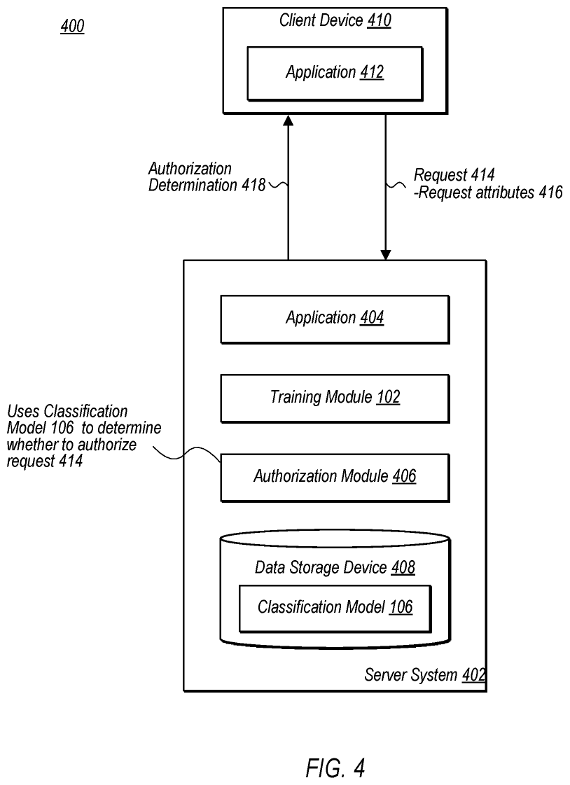

Referring now to FIG. 4, block diagram 400 depicts a server system 402 that hosts an application 404 and includes a training module 102, authorization module 406, and a data storage device 408 storing classification model 106. In various embodiments, authorization module 406 is operable to use the classification model 106 (e.g., the “second version” of the classification model 106 after the second training phase has been completed) to determine whether to authorize a request 414 from a client device 410. For example, in various embodiments, server system 402 may host application 404 (e.g., as part of a web service) that may be used directly by end users or that may be integrated with (or otherwise used by) web services provided by third parties. As one example, server system 402, in some embodiments, provides an online payment service that may be used by end users to perform online financial transactions (e.g., sending or receiving funds) or utilized by merchants to receive funds from users during financial transactions. Note, however, that this embodiment is described merely as one non-limiting example. In other embodiments, server system 402 may provide any of various suitable web services and host any of various suitable types of applications 404. In still other embodiments, server system 402 may operate as an authorization server that provides authorization services (e.g., for third-party web services) and does not necessarily provide any other web services.

In the depicted embodiment, a user of the client device 410 may use an application 412 (e.g., a web browser) to send a request 414 to access, or perform some operation via, application 404 hosted by server system 402. For example, in instances in which the server system 402 provides an online payment service, the request 414 may be a request to perform a transaction via the online payment service. In various embodiments, the request 414 may have various associated attributes 416. Continuing with the example in which the request 414 is to perform an electronic transaction, the attributes 416 may include: account information regarding the parties to the requested transaction, an amount of the requested transaction, a time at which the request 414 was initiated, a geographic location from which the request 414 was sent, the number of transactions attempted using the client device 410, or any of various other suitable attributes.

In various embodiments, the authorization module 406 may determine whether to authorize the request 414 using the classification model 106. For example, in some embodiments, the authorization module 406 may create an input feature vector based on the attributes 416 and apply that feature vector as input to the classification model 106 that has been trained using the multi-phase training techniques disclosed herein. In various embodiments, the classification model 106 may generate a corresponding model score indicating the probability that the request should be classified into one of a set of two or more classes. For example, in instances in which the classification model 106 has been trained, as disclosed herein, to classify attempted electronic transactions as either “fraudulent” or “not fraudulent” (e.g., using a training dataset 104 that includes training samples 105 corresponding to prior electronic transactions), the classification model 106 may generate a model score 206 for the request 414, indicating the probability that the requested transaction should be classified as either “fraudulent” or “not fraudulent.” Based on this model score 206, the authorization module 406 may determine whether to authorize the request 414. For example, if the model score 206 is above some specified threshold (e.g., 98%), the authorization module 406 may determine that the requested transaction should be classified as fraudulent and take one or more corrective actions (e.g., deny the request 414). Note, however, that this embodiment is provided merely as one non-limiting example. In other embodiments, the classification model 106 may be used to address any suitable type of binary or multi-label classification problem, as desired.

Note that, in some embodiments, server system 402 may be separate from the computer system 110 of FIGS. 1-3 that generates the updated version of the machine learning classification model 106. Stated differently, in some embodiments, the same entity may both generate the updated version of the classification model 106 and use the classification model 106 in a production environment to classify input elements based on live data. In other embodiments, the classification model 106 may be generated by one entity, such as the computer system 110, and utilized in a production environment by a second, different entity, such as the server system 402.

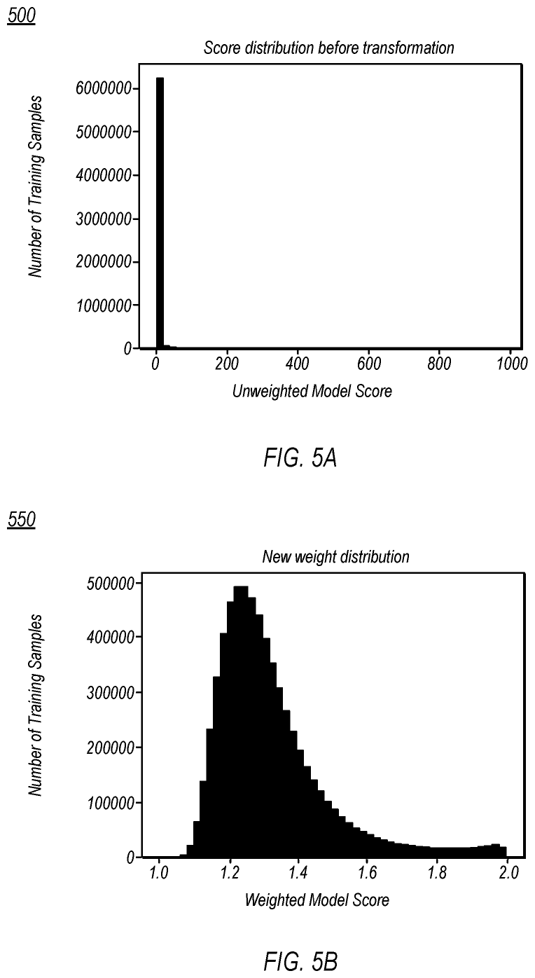

Turning now to FIGS. 5A-5B, graphs 500 and 550 respectively depict example distributions of unweighted model scores 206 for the training samples 105 in a training dataset 104 and model scores 206 that have been weighted using corresponding weighting values 108, according to one non-limiting embodiment. In FIG. 5A, graph 500 depicts a distribution in which the model scores 206 for the majority of the training samples 105 are close to 0, resulting in a heavily skewed distribution in the training dataset 104. As discussed above, in various embodiments, training a classification model solely on a training dataset with such a distribution may negatively impact the efficacy of the resulting classification model. (Note that, in FIG. 5A, the scale of the x-axis has been modified for clarity. More specifically, in FIG. 5A, the x-axis has been scaled by 1000 such that a value of 1000 on the x-axis corresponds to a model score of 1.0, a value of 800 on the x-axis corresponds to a model score of 0.8, etc.)

In various embodiments, however, the disclosed techniques may be used, during the second training phase, to weight the loss associated with the model scores 206 for the training samples 105, using the corresponding weighting values 108, such that more emphasis is placed on training samples 105 for which the model scores 206 fall into a higher portion of the model score distribution. For example, referring to FIG. 5B, graph 550 depicts a distribution of the model scores 206 of the training samples 105 in the training dataset 104 once those training samples 105 have been weighted using the corresponding weighting values 108. As shown in FIG. 5B, the distribution of weighted training samples is less skewed and more closely resembles a Gaussian distribution, which, as discussed above, may provide various technical benefits. For example, by training a classification model based on a training dataset with such a distribution during a second training phase, the disclosed techniques are operable to generate a classification model that is more accurate in an upper portion of the model score distribution, which may be particularly advantageous when the classification model is used to classify elements for which the decision threshold is in the upper portion of the distribution.

### Example Methods

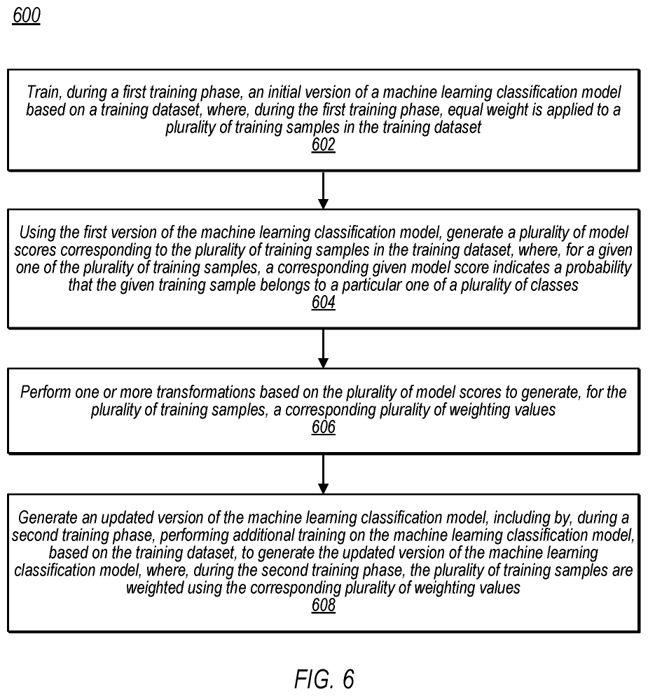

Referring now to FIG. 6, a flow diagram illustrating an example method 600 for training a machine learning classification model using a multi-phase training operation is depicted, according to some embodiments. In various embodiments, method 600 may be performed by training module 102 executing on computer system 110 of FIGS. 1-3 to train an updated version of classification model 106. For example, computer system 110 may include (or have access to) a non-transitory, computer-readable medium having program instructions stored thereon that are executable by computer system 110 to cause the operations described with reference to FIG. 6. In FIG. 6, method 600 includes elements 602-608. While these elements are shown in a particular order for ease of understanding, other orders may be used. In various embodiments, some of the method elements may be performed concurrently, in a different order than shown, or may be omitted. Additional method elements may also be performed as desired.

At 602, in the illustrated embodiment, computer system trains, during a first training phase, an initial version of a machine learning classification model based on a training dataset, where, during the first training phase, equal weight is applied to a plurality of training samples in the training dataset. For example, in various embodiments, the training module 102 may train the initial version of classification model 106 based on the training samples 105 in training dataset 104. As noted above, in various embodiments, the machine learning classification model is implemented using an ANN, which may use any of various suitable ANN architectures. Further, in some embodiments, the machine learning classification model 106 may be a binary classification model that is operable to classify an input element into one of two classes. As one non-limiting example, in some embodiments, the machine learning classification model 106 is trained to detect fraudulent transactions in an online payment system. In some such embodiments, the plurality of training samples may correspond to a plurality of prior electronic transactions, where a first training sample, corresponding to a first one of the plurality of prior electronic transactions, indicates one or more attributes associated with the first prior electronic transaction, and a label classifying the first prior electronic transaction into one of a plurality of classes (e.g., either “fraudulent” or “not fraudulent”).

At 604, in the illustrated embodiment, the computer system uses the initial version of the machine learning classification model to generate a plurality of model scores corresponding to the plurality of training samples in the training dataset 104. For example, as shown in FIG. 2, computer system 110 may use the initial version of the machine learning classification model 106 to generate the model scores 206 corresponding to the training samples 105 in the training dataset 104. In various embodiments, for a given training sample, a corresponding model score (from the initial version of the machine learning classification model) indicates a probability that the given training sample belongs to a particular one of a plurality of classes. As one non-limiting embodiment, in an instance in which the initial version of the machine learning classification model 106 is a binary classification model that has been trained (in element 602) based on prior electronic transaction data to detect fraudulent transactions, a model score 206 (specified, for example, as a value between 0.0-1.0) for a given training sample 105 may indicate the probability that the given training sample 105 should be classified as “fraudulent.”

At 606, in the illustrated embodiment, the computer system performs one or more transformations based on the plurality of model scores to generate, for the plurality of training samples, a corresponding plurality of weighting values. For example, as described above in reference to FIG. 2, the weighting value generator 208 is operable to generate weighting values 108 for the training samples 105 based on the model scores 206. In some embodiments, there is a positive relationship between the model scores 206 and the corresponding weighting values 108. That is, in some embodiments, the weighting values 108 are generated such that a first training sample with a first model score is given a higher weighting value than a second training sample with a second, lower model score. As one non-limiting example, in some embodiments, the weighting values 108 are generated based on the logarithm of one or more of the model scores 206. For example, in some such embodiments, for a first training sample 105A that has a corresponding model score 206A, performing the one or more transformations at element 606 includes performing a logarithmic function (e.g., the natural logarithm) on the corresponding model score 206A to generate a first logarithmic value. The weighting value generator 208 may then normalize the first logarithmic value based on both a highest one of a plurality of logarithmic values generated based on the plurality of model scores, and a lowest one of the plurality of logarithmic values generated based on the plurality of model scores. In some such embodiments, the weighting value generator 208 may then generate a first weighting value 108A for the first training sample 105A based on the first normalized logarithmic value.

At 608, in the illustrated embodiment, the computer system generates an updated version of the machine learning classification model in which, during a second training phase, the computer system performs additional training on the machine learning classification model, based on the training dataset, to generate the updated version of the machine learning classification model. In various embodiments, during this second training phase, the plurality of training samples 105 are weighted using the corresponding plurality of weighting values 108. In some embodiments, performing the additional training to generate the updated version of the machine learning classification model 106 includes applying an optimization algorithm (e.g., the Adam optimization algorithm) to modify one or more parameters of the machine learning classification model 106, where the optimization algorithm uses a particular loss function to evaluate a performance of the machine learning classification model 106. In various embodiments, any suitable loss function may be used, such as the binary cross-entropy loss function. In various embodiments, the optimization algorithm may use the particular loss function to evaluate a performance of the machine learning classification model 106 for a given training sample 105A and, for the given training sample 105A, a corresponding loss value generated using the particular loss function is weighted based on a given weighting value 108A associated with the given training sample 105A, as described in more detail above with reference to FIG. 3. Note that, in some embodiments, different learning rates may be used in the first and second training phases. For example, in some embodiments, the first training phase may use a first learning rate to train the initial version of the machine learning classification model 106 and the second training phase may use a second, lower learning rate to train the updated version of the machine learning classification model 106, which may help prevent overshooting.

In some embodiments, the updated version of the machine learning classification model 106 may be used in a “production” environment to classify input elements based on live data from users. In the non-limiting example described above with reference to FIG. 4, for instance, the updated version of the machine learning classification model 106 may be used to determine whether to authorize a request 414 provided via a client device 410. For example, in some such embodiments, the computer system 110 may receive an authorization request corresponding to an electronic transaction, where the authorization request specifies one or more attributes associated with the electronic transaction. The computer system 110 may then apply information corresponding to the one or more attributes associated with the second electronic transaction as input (e.g., as an input feature vector) to the updated version of the machine learning classification model 106 to generate a predicted classification for the electronic transaction. Based on this predicted classification, the computer system 110 may then determine whether to authorize the electronic transaction, according to some embodiments.

### Example Computer System

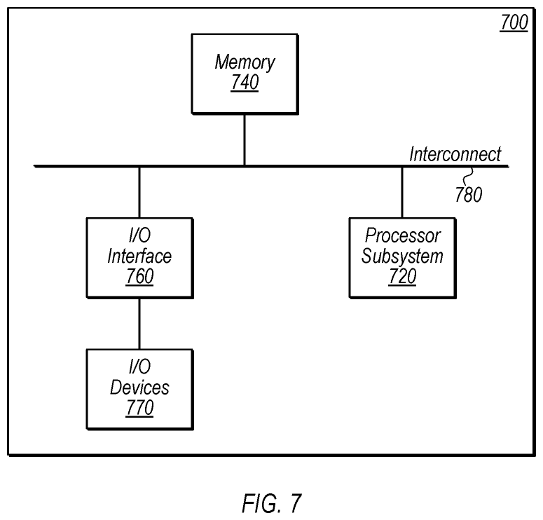

Referring now to FIG. 7, a block diagram of an example computer system 700 is depicted, which may implement one or more computer systems, such as computer system 110 of FIG. 1 or server system 402 of FIG. 4, according to various embodiments. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 700 is shown in FIG. 7 for convenience, computer system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as system memory 740. Rather, computer system 700 may also include other forms of storage such as cache memory in processor subsystem 720 and secondary storage on I/O devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 770 includes a network interface device (e.g., configured to communicate over WiFi, Bluetooth, Ethernet, etc.), and computer system 700 is coupled to a network via the network interface device.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

Unless stated otherwise, the specific embodiments described herein are not intended to limit the scope of claims that are drafted based on this disclosure to the disclosed forms, even where only a single example is described with respect to a particular feature. The disclosed embodiments are thus intended to be illustrative rather than restrictive, absent any statements to the contrary. The application is intended to cover such alternatives, modifications, and equivalents that would be apparent to a person skilled in the art having the benefit of this disclosure.

Particular features, structures, or characteristics may be combined in any suitable manner consistent with this disclosure. The disclosure is thus intended to include any feature or combination of features disclosed herein (either explicitly or implicitly), or any generalization thereof. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

For example, while the appended dependent claims are drafted such that each depends on a single other claim, additional dependencies are also contemplated, including the following: Claim 3 (could depend from any of claims 1-2); claim 4 (any preceding claim); claim 5 (claim 4), etc. Where appropriate, it is also contemplated that claims drafted in one statutory type (e.g., apparatus) suggest corresponding claims of another statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to the singular forms such “a,” “an,” and “the” are intended to mean “one or more” unless the context clearly dictates otherwise. Reference to “an item” in a claim thus does not preclude additional instances of the item.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” covering x but not y, y but not x, and both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one of element of the set [w, x, y, z], thereby covering all possible combinations in this list of options. This phrase is not to be interpreted to require that there is at least one instance of w, at least one instance of x, at least one instance of y, and at least one instance of z.

Various “labels” may proceed nouns in this disclosure. Unless context provides otherwise, different labels used for a feature (e.g., “first circuit,” “second circuit,” “particular circuit,” “given circuit,” etc.) refer to different instances of the feature. The labels “first,” “second,” and “third” when applied to a particular feature do not imply any type of ordering (e.g., spatial, temporal, logical, etc.), unless stated otherwise.

Within this disclosure, different entities (which may variously be referred to as “units,” “circuits,” other components, etc.) may be described or claimed as “configured” to perform one or more tasks or operations. This formulation—“[entity] configured to [perform one or more tasks]”—is used herein to refer to structure (i.e., something physical). More specifically, this formulation is used to indicate that this structure is arranged to perform the one or more tasks during operation. A structure can be said to be “configured to” perform some task even if the structure is not currently being operated. A “data storage device configured to store a classification model” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function. This unprogrammed FPGA may be “configurable to” perform that function, however.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for [performing a function]” construct.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

In this disclosure, various “modules” operable to perform designated functions are shown in the figures and described in detail (e.g., training module 102). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. Accordingly, a module that is described as being “executable” to perform operations refers to a software module, while a module that is described as being “configured” to perform operations refers to a hardware module. A module that is described as “operable” to perform operations refers to a software module, a hardware module, or some combination thereof. Further, for any discussion herein that refers to a module that is “executable” to perform certain operations, it is to be understood that those operations may be implemented, in other embodiments, by a hardware module “configured” to perform the operations, and vice versa.

What is claimed is:

1. A method, comprising:
a computer system training, in a first training phase, an initial version of a machine learning classification model based on a training dataset, wherein, during the first training phase, equal weight is applied to a plurality of training samples in the training dataset;
using the initial version of the machine learning classification model, the computer system generating a plurality of model scores corresponding to the plurality of training samples in the training dataset, wherein, for a given one of the plurality of training samples, a corresponding given model score from the initial version of the machine learning classification model indicates a probability that the given training sample belongs to a particular one of a plurality of classes;
performing, by the computer system, one or more transformations based on the plurality of model scores to generate, for the plurality of training samples, a corresponding plurality of weighting values; and
the computer system generating an updated version of the machine learning classification model, including the computer system, during a second training phase, performing additional training on the machine learning classification model, based on the training dataset, to generate the updated version of the machine learning classification model, wherein, during the second training phase, the plurality of training samples are weighted using the corresponding plurality of weighting values.

2. The method of claim 1, wherein the corresponding plurality of weighting values are generated such that a first training sample with a first model score is given a higher weighting value than a second training sample with a second, lower model score.

3. The method of claim 1, wherein the performing the additional training includes:
applying an optimization algorithm to modify one or more parameters of the machine learning classification model, wherein the optimization algorithm uses a particular loss function to evaluate a performance of the machine learning classification model for a given one of the plurality of training samples, and wherein, for the given training sample, a corresponding loss value generated using the particular loss function is weighted based on a given weighting value associated with the given training sample.

4. The method of claim 3, wherein the particular loss function includes a binary cross-entropy loss function.

5. The method of claim 1, wherein the first training phase uses a first learning rate to train the initial version of the machine learning classification model, and wherein the second training phase uses a second, lower learning rate to train the updated version of the machine learning classification model.

6. The method of claim 1, wherein, for a first training sample, of the plurality of training samples, that has a first corresponding model score, the performing the one or more transformations includes:
performing a logarithmic function on the first corresponding model score to generate a first logarithmic value;
normalizing the first logarithmic value based on:
a highest one of a plurality of logarithmic values generated based on the plurality of model scores; and
a lowest one of the plurality of logarithmic values generated based on the plurality of model scores; and
generating a first weighting value for the first training sample based on the normalized first logarithmic value.

7. The method of claim 1, wherein the machine learning classification model is implemented using an artificial neural network (ANN).

8. The method of claim 1, wherein the machine learning classification model is a binary classification model.

9. The method of claim 1, wherein the plurality of training samples correspond to a plurality of prior electronic transactions, and wherein a first training sample, corresponding to a first one of the plurality of prior electronic transactions, indicates:
one or more attributes associated with the first prior electronic transaction; and
a label classifying the first prior electronic transaction into one of a plurality of classes.

10. The method of claim 9, further comprising:
receiving, by the computer system, an authorization request corresponding to a second electronic transaction, wherein the authorization request specifies one or more attributes associated with the second electronic transaction;
applying, by the computer system, information corresponding to the one or more attributes associated with the second electronic transaction as input to the updated version of the machine learning classification model to generate a predicted classification for the second electronic transaction; and
determining, by the computer system, whether to authorize the second electronic transaction based on the predicted classification.

11. A non-transitory, computer-readable medium having instructions stored thereon that are executable by a computer system to perform operations comprising:
performing a first training phase to generate an initial version of a machine learning classification model, wherein, during the first training phase, equal weighting is applied to a plurality of training samples in a training dataset;
generating, for the plurality of training samples, a corresponding plurality of weighting values, wherein, for a given one of the plurality of training samples, generating a corresponding weighting value includes:
generating a model score for the given training sample using the initial version of the machine learning classification model; and
generating the corresponding weighting value, for the given training sample, based on the model score; and
based on the training dataset, performing a second training phase to generate an updated version of the machine learning classification model, including by:
using values for one or more parameters of the initial version of the machine learning classification model as initial values for one or more parameters of the updated version of the machine learning classification model; and
applying an optimization algorithm to modify the initial values for the one or more parameters of the updated version of the machine learning classification model;
wherein, during the second training phase, the plurality of training samples are weighted using the corresponding plurality of weighting values.

12. The non-transitory, computer-readable medium of claim 11, wherein the optimization algorithm uses a particular loss function to evaluate a performance of the machine learning classification model for a given one of the plurality of training samples, and wherein, for the given training sample, a corresponding loss value generated using the particular loss function is weighted based on a given weighting value associated with the given training sample.

13. The non-transitory, computer-readable medium of claim 11, wherein the machine learning classification model is implemented using an ANN; and
wherein the corresponding plurality of weighting values are generated such that a first training sample with a first model score is given a higher weighting value than a second training sample with a second, lower model score.

14. The non-transitory, computer-readable medium of claim 11, wherein, for the given training sample, generating the corresponding weighting value includes:
performing a logarithmic function on the model score to generate a first logarithmic value; normalizing the first logarithmic value based on:
a highest one of a plurality of logarithmic values generated based on a plurality of model scores corresponding to the plurality of training samples; and
a lowest one of the plurality of logarithmic values generated based on the plurality of model scores; and
generating a first weighting value for the given training sample based on the normalized first logarithmic value.

15. The non-transitory, computer-readable medium of claim 11, wherein the machine learning classification model is a binary classification model; and
wherein the plurality of training samples correspond to a plurality of prior electronic transactions, and wherein a first training sample, corresponding to a first one of the plurality of prior electronic transactions, indicates:
one or more attributes associated with the first prior electronic transaction; and
a label classifying the first prior electronic transaction as fraudulent or not fraudulent.

16. A system, comprising:
at least one processor;
a non-transitory, computer-readable medium having instructions stored thereon that are executable by the at least one processor to cause the system to:
access information corresponding to an initial version of a machine learning classification model that was trained, during an initial training phase, with equal weighting applied to a plurality of training samples in a training dataset;
generate, for the plurality of training samples, a plurality of model scores using the initial version of the machine learning classification model, wherein, for a given one of the plurality of training samples, a corresponding model score indicates a probability that the given training sample corresponds to a particular one of a plurality of classes;
based on the plurality of model scores, determine a plurality of weighting values corresponding to the plurality of training samples; and
generate an updated version of the machine learning classification model during a second training phase in which the plurality of training samples in the training dataset are weighted using the plurality of weighting values, wherein the second training phase includes:
using values for one or more parameters of the initial version of the machine learning classification model as initial values for one or more parameters of the updated version of the machine learning classification model; and
performing additional training operations to optimize values for the one or more parameters of the machine learning classification model.

17. The system of claim 16, wherein the performing the additional training operations includes:
applying an optimization algorithm to optimize the values for the one or more parameters of the machine learning classification model, wherein the optimization algorithm uses a particular loss function to evaluate a performance of the machine learning classification model for a given one of the plurality of training samples, and wherein, for the given training sample, a corresponding loss value generated using the particular loss function is weighted based on a given weighting value associated with the given training sample.

18. The system of claim 16, wherein, for a first training sample, of the plurality of training samples, that has a first corresponding model score, determining a corresponding first weighting value includes:
performing a logarithmic function on the first corresponding model score to generate a first logarithmic value;
normalizing the first logarithmic value based on:
a highest one of a plurality of logarithmic values generated based on the plurality of model scores; and
a lowest one of the plurality of logarithmic values generated based on the plurality of model scores; and
generating the corresponding first weighting value for the first training sample based on the normalized first logarithmic value.

19. The system of claim 16, wherein the plurality of training samples correspond to a plurality of prior electronic transactions, and wherein a first training sample, corresponding to a first one of the plurality of prior electronic transactions, indicates:
one or more attributes associated with the first prior electronic transaction; and
a label classifying the first prior electronic transaction into one of a plurality of classes.

20. The system of claim 19, wherein the instructions are further executable to cause the system to:
receive an authorization request corresponding to a second electronic transaction, wherein the authorization request specifies one or more attributes associated with the second electronic transaction;
apply information corresponding to the one or more attributes associated with the second electronic transaction as input to the updated version of the machine learning classification model to generate a predicted classification for the second electronic transaction; and
determine whether to authorize the second electronic transaction based on the predicted classification.
